(19) United States
(12) Patent Application Publication
(10) Pub. No.: US 2023/0255403 A1
(43) Pub. Date: Aug. 17, 2023

(54) Outdoor Barbecue Grill with Automatic Temperature-Dependent Grill Height Adjustment

(71) Applicant: Next Level BBQ LLC, Nipomo, CA (US)

(72) Inventors: Brett Mitchell, Nipomo, CA (US); Jeremy Thomas McMillin, Santa Barbara, CA (US)

(73) Assignee: Next Level BBQ LLC, Nipomo, CA (US)

(21) Appl. No.: 18/110,316

(22) Filed: Feb. 15, 2023

Related U.S. Application Data
(60) Provisional application No. 63/268,009, filed on Feb. 15, 2022.

(51) Int. Cl. A47J 37/07

(52) U.S. Cl. CPC A47J 37/0786; A47J 37/0745; A47J 2037/0795

(57) ABSTRACT

A barbecue grill that includes a table defining a chamber to receive combustible fuel and a grill basket having a grill platform arranged facing the chamber and adapted to be moved vertically between a lowest position and a highest position and multiple positions therebetween. The grill includes an electric motor operatively connected to the grill platform to move the grill basket between its lowest and highest positions, and a plurality of temperature sensors adapted to monitor a temperature of the grill platform. A controller is arranged in communication with the plurality of temperature sensors and the electric motor and is configured to raise and lower the grill basket to maintain the grill platform at a desired temperature.

### CROSS REFERENCES TO RELATED APPLICATIONS

The present application claims the benefit of U.S. Provisional Patent Application Ser. No. 63/268,009, filed Feb. 15, 2022 (Feb. 15, 2022), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### TECHNICAL FIELD

### Background of the Invention

### Field of the Invention

The present invention relates most generally, relates to an outdoor barbecue grill, and more particularly to a barbecue grill with a motorized grill height adjustment system that automatically lowers and raises the grill platform according to user inputs into a programmable grill motor controller.

### Background Discussion

Grills, such as, Santa Maria style grills, are known in the art and are used for cooking foods, principally including meats and vegetables. Such grills include a grill platform arranged directly above a fire pit to facilitate the cooking of the food. Typically, the grill platform is positioned manually at a certain height relative to the fire pit by raising and/or lowering the grill platform relative to the fire pit to cook the food at a desired temperature. The grill placement is typically done before starting the fire or just before cooking commences, though it may be adjusted manually at any time during the cooking process, albeit with some challenges owing to the grill temperature and proximity to the flame. However, it is difficult to maintain the temperature of the food arranged at the grill platform at a desired temperature level because wood and coal fires can change temperature dramatically over even short periods of time. This can result in either burning/overcooking of the food or undercooking of the food, both obviously undesirable.

### BRIEF SUMMARY OF THE INVENTION

According to embodiments, the inventive grill includes a table defining a chamber to receive wood and a grill basket having a grill platform arranged facing the chamber and adapted to be displaced between a first position and a second position in a vertical direction. The grill also includes an electric motor adapted to displace the grill basket between the first position and the second position, and a plurality of temperature sensors adapted to monitor a temperature of the grill platform. A controller is arranged in communication to the plurality of temperature sensors and the electric motor and is configured to raise and lower the grill basket to maintain the grill platform at a desired temperature.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention, which will form the subject matter of the claims appended hereto.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways. As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an upper right front perspective view of an embodiment of the inventive barbecue grill with automatic temperature-dependent grill height adjustment;

FIG. 2 is an upper front perspective view of a carriage assembly and a bracket assembly movably coupled to the carriage assembly, in accordance with an embodiment of the invention;

FIG. 3 is a front perspective view of the carriage assembly in accordance with an embodiment of the invention;

FIG. 4 is an upper front perspective view of the grill basket of the grill, in accordance with an embodiment of the invention; and

FIG. 5 is a highly schematic diagram of a system for controlling the height adjustment operation of the grill, in accordance with an embodiment of the invention.

### DETAILED DESCRIPTION OF THE INVENTION

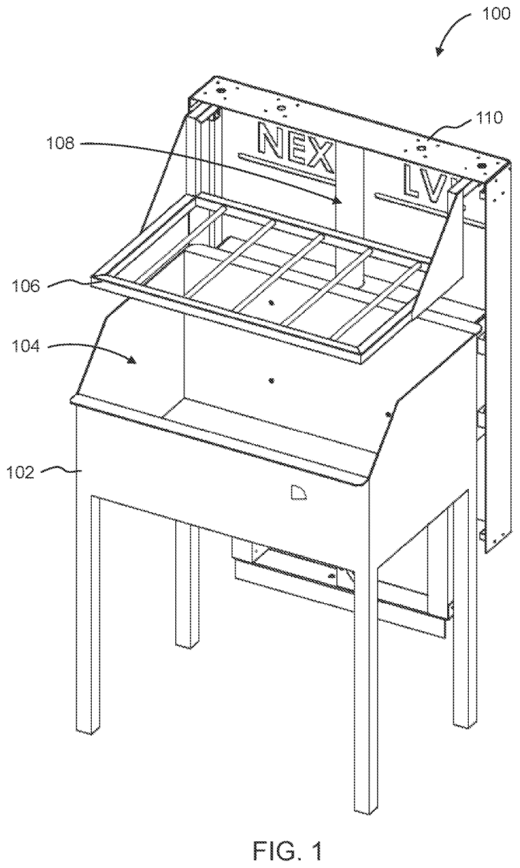

Referring now to FIG. 1, there is shown a barbecue grill with automatic temperature-dependent height adjustment 100 for barbecue cooking of various food products. As shown in this view, the grill 100 is a Santa Maria style barbeque grill and includes a cooking platform or table 102 with an integral well defining a fuel burning chamber 104 for receiving wood or charcoal or coal or other similar material to start and maintain a fire and/or burning coals. The grill further includes a grill basket 106 arranged above the chamber 104, which is configured to move vertically between a lowest and a highest position relative to the chamber 104, with effectively infinite intermediate positions therebetween. The grill also includes a carriage assembly 108 mounted to the table 102 and adapted to move the grill basket 106 to and between the lowest and highest positions. In the lowest position, the grill basket 106 (simply “basket” herein) is arranged proximate to the chamber 104, while in the highest position, the grill basket 106 is arranged distally (i.e., more remotely) from the chamber 104. Accordingly, the grill basket 106 moves vertically up from the lowest to the highest positions, while it moves vertically down when moved from the highest to the lowest position.

Further, the grill 100 includes a bracket assembly 110 movably coupling the grill basket 106 to the carriage assembly 108.

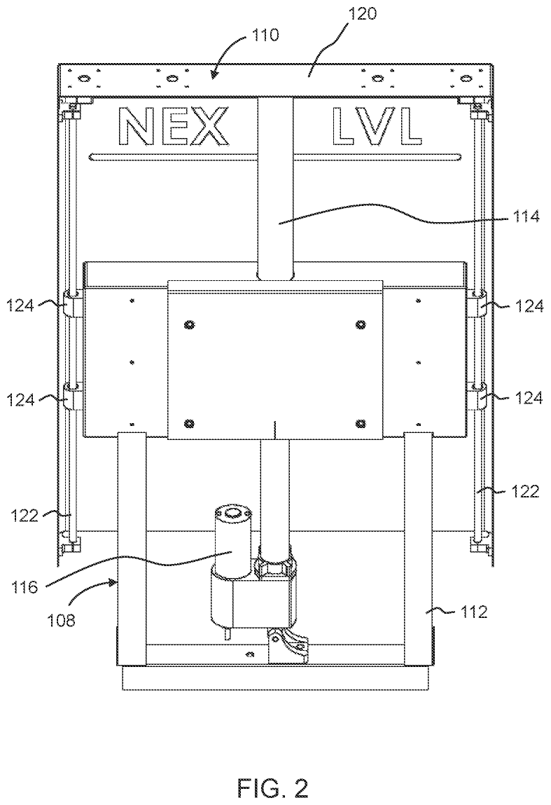

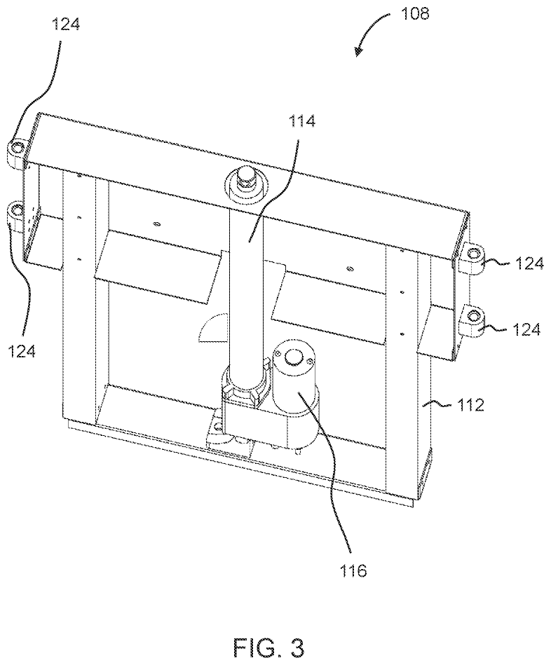

As shown in FIGS. 2-3, the carriage assembly 108 includes a frame 112 affixed to the table 102, a telescopic cylinder 114 having a first end attached to the frame 112 and a second end attached to the bracket assembly 110. The bracket assembly 110 moves up and down as the telescopic cylinder 114 is mechanically extended and retracted, respectively. To extend or retract the telescopic cylinder 114, the carriage assembly 108 includes an electric motor 116 operatively coupled to the telescopic cylinder 114. In an embodiment, the telescopic cylinder 114 is part of a linear axis drive of linear drive system that extends or retracts according to the direction of rotation of the electric motor 116. Gear coupling from the motor to the telescopic cylinder may be through any of a number of suitable gear drives, including, by way of example, a screw drive, a rack and pinion gear drive, or a worm drive.

It may be appreciated that the grill basket 106 is arranged at the lowest position in the fully retracted configuration of the telescopic cylinder 114, and it is arranged at the highest position in the fully extended configuration of the telescopic cylinder 114.

As shown in FIG. 2, the second end of the telescopic cylinder 114 engages a top end of a bracket 120 of the bracket assembly 110. The engagement is not secured, such that if an obstruction prevents the grill basked 106 from moving downwardly, the telescoping rod can still move freely, thus preventing stress and possibly damage to the frame. The bracket 120 is adapted to move relative to the frame 112 of the carriage assembly in response to the extension and retraction of the telescopic cylinder 114, and it is securely affixed to the basket 106. To facilitate vertical movement of the bracket 120 relative to the frame 112, the bracket assembly 110 includes a pair of guide rods 122 connected to the bracket 120 and extending through a plurality of guide brackets 124 of the carriage assembly 108. The guide brackets 124 are affixed to the frame 112 and are configured to guide the smooth vertical motion of the guide rods 122 of the bracket assembly 110. As shown, the guide rods 122, and hence the bracket assembly 110, move up and down relative to the guide brackets 124 as the telescopic cylinder 114 is extended and retracted.

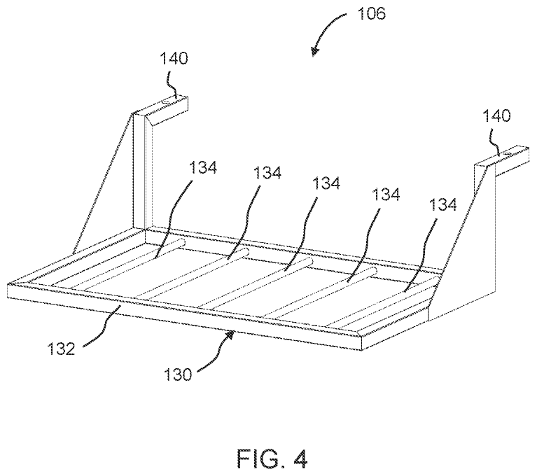

As shown in FIG. 4, the grill basket 106 includes a grill platform 130 adapted for arrangement and positioning directly above the chamber 104, and it is adapted to support cooking food product on its upper surface. As shown, the grill platform 130 includes an outer frame 132 and a plurality of horizontally disposed rods 134 arrayed along a length of the grill platform 130 and attached to the outer frame 132. Food is placed atop the rods 134 in a very well-known manner. Further, the grill basket 106 includes a pair of arms 140 arranged at the lateral ends of the platform 130 and connecting the outer frame 132 to the bracket 120.

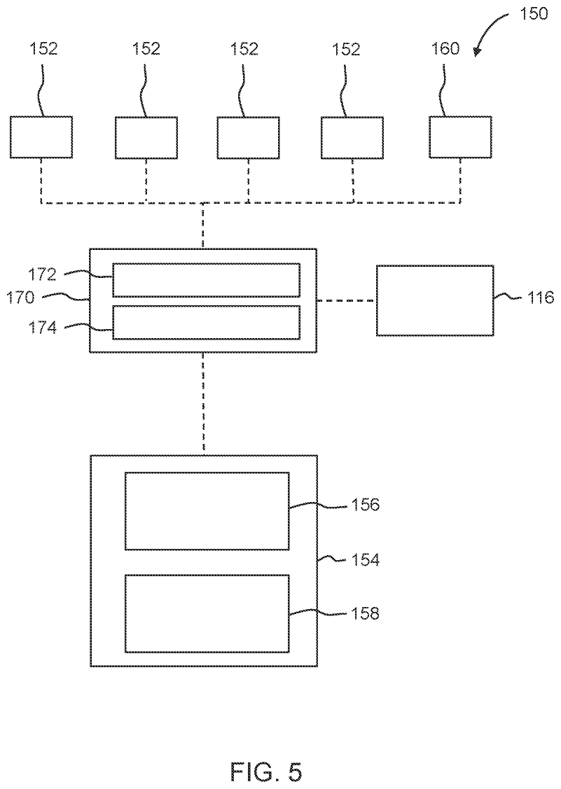

Further still, and referring now to FIG. 5, the grill 100 includes a control system 150 for controlling the height adjustment operation of the grill basket 106. The control system includes a plurality of temperature sensors 152 to detect and determine a temperature of the grill platform 130. In an embodiment, the temperature sensors 152 are mounted on the grill platform 130, for example, on the outer frame 132 of the grill platform 130. Alternatively, the temperature sensors, e.g., thermocouples, may be inserted or otherwise incorporated into cylindrical cavities in the grill rods 134.

The control system further includes a user interface 154 having a visual display 156 and input means 158, for example, a keypad or touchscreen, to enable a user to select various cooking modes available to the user. Also, the user interface 154 may allow the user to input a desired temperature at which the food is to be cooked. In an embodiment, the user can select the desired temperature from a drop-down menu or other visual listing displayed by the display device 156. In some embodiments, the user can manually enter the desired temperature via the input device 158. In some embodiments, the user interface 154 may be onboard or otherwise incorporated into the grill 100. In some embodiments, the user interface 154 may also or instead be an application installed on computing device, such as, but not limited to, a smart phone, a laptop, a desktop computer, a tablet, etc.

Additionally, the system may include at least one temperature probe 160 adapted for insertion inside the food (i.e., meat) to be placed on the grill platform 130 for cooking. The temperature probe 160 is adapted to determine a temperature of the food during cooking and to transmit a signal indicating food product temperature. The control system may be programmed to adjust grill height according to product temperature and/or a cooking rate.

The control system 150 next includes a controller 170 in wired or wireless electronic communication with one or more of the plurality of temperature sensors 152, the electric motor 116, the temperature probes 160, and the user interface 154, and it controls the height-adjustment operation of the grill basket 106. The controller 170 may be capable of processing signals received from the plurality of temperature sensors 152, the temperature probe 160, and the user interface 154, and outputting command and control signals to the electric motor 116.

As noted, in embodiments, one or more temperature sensors not physically connected to the grill may be provided. For instance, wired or wireless meat temperature sensors in wired or wireless communication with the control system may be employed, and temperature readings from cooking food product may be used by the control system to raise or lower grill height in response to either or both instantaneous temperature readings and temperatures rates of change, so as to ensure that food product reaches a predetermined optimum finish cooking temperature at a desired time.

In an embodiment, the controller 170 may be in communication with the display device 156 to display one or more operating parameters of the grill 100. In an embodiment, the controller 170 is configured to display, via the display device 156, various cooking modes available to the user. The controller 170 may also display, via the display device 156, the temperature of the grill platform 130 and/or the temperature detected by the temperature probe 160. In an embodiment, the controller 170 is adapted to control the raising and a lowering of the grill platform 130 relative to the chamber 104 based on the temperatures detected by the temperature sensors 152. In an embodiment, the controller 170 is configured to control the raising and lowering of the grill platform 130 based on the cooking mode selected by the user.

The controller 170 may include a processor 172 for executing specified instructions both preprogrammed and input by a user. The processor 172 may be operatively connected to a memory 174 for storing instructions related to the height-adjustment control of the grill basket 106 and other grill components. In an embodiment, the memory 174 may also store various cooking events/operations performed on the grill 100. The memory 174 may also store various cooking modes available corresponding to each type of food.

The memory 174 as illustrated is integrated into the controller 170, but those skilled in the art will understand that the memory 174 may be separate from the controller 170 while either still onboard the grill 100 or remote from the controller 170 and the grill 100, while still being associated with and accessible by the controller 170 to store information in and to retrieve information from the memory 174 as necessary during grill use.

Although a processor 172 is shown here, it is also possible and contemplated to use other electronic components, such as a microcontroller, an application specific integrated circuit (ASIC) chip, or any other integrated circuit device to effect system control. Moreover, the controller 170 may refer collectively to multiple control and processing devices across which the functionality of the grill 100 and other systems of the grill may be distributed. For example, the electric motor 116, the temperature sensors 152, the temperature probe 160, and the user interface 154 may each have one or more controllers that communicate with the controller 170.

A method for cooking a food using the grill 100 is now described. The method includes placing a combustible fuel, for example, wood, coal, or charcoal, inside the chamber 104 and igniting the fuel to start a fire underneath the grill platform 130. Thereafter, a user may press a switch or key on the user interface 154 to raise the grill platform 130 to a higher position. The method may include selecting the type of food, for example, beef, pork, etc., and the type of cooking mode (viz., preferred doneness or finish temperature), for example, medium, medium rare, rare, etc., from the user interface 154, and placing the food on the grill platform 130 with or without a temperature probe 160 inserted into the food. After positioning the food on the grill platform 130, the user may initiate a cooking cycle by pressing a start button on the user interface 154. Before pressing the start button, the user may select and input a desired temperature at which the user wishes to cook the food.

In an embodiment, the processor 172, via the display device 156, shows one or more temperatures available at which the food can be cooked. The one or more available temperatures may depend on the type of food and/or the type of cooking, and the user may select the desired temperature from the one or more available temperature via the user interface 154. Alternatively, or additionally, the user may input a value of the temperature through the user interface 154 and the controller 170 may store the temperature value in the memory 174 as the desired cooking temperature. Based on the desired temperature, the processor 172 may determine a maximum temperature value and a minimum temperature value within which a temperature of the grill platform 130 is to be maintained. Then, based on the desired temperature, the maximum temperature value, and the minimum temperature value, the processor 172 controls the height of the platform 130 by raising or lowering it to position the grill at a height from the burning fuel to maintain the temperature of the grill platform 130 at the desired temperature or within the desired temperature range.

To control elevation of the grill platform, the processor 172 controls the electric motor 116. When the user presses the start button, the processor 172 lowers the grill platform 130 by actuating the electric motor 116 such that the telescopic cylinder 114 is retracted.

As the grill platform 130 moves towards the lowest position, the processor 172 monitors the temperature of the grill platform 130 based on the signals received from the plurality of temperature sensors 152 mounted on the grill platform 130. The processor 172 determines or calculates the temperature of the grill platform 130 by taking an average of the temperature values detected by the plurality of temperature sensors 152. In an embodiment, the processor 172 stops lowering the grill platform 130 when the processor 172 determines that temperature of the grill platform 130 has reached a desired temperature or temperature within a temperature range. Subsequently, the processor 172 continues monitoring the temperature of the grill platform 130 and raises or lowers the grill platform to keep its temperature within the desired range.

In an embodiment, the processor 172 raises the grill platform 130 upon a lapse of a first predefined time duration, for example 10 seconds, after determining that the temperature of the grill platform 130 is equal to or above the maximum temperature value. In an embodiment, the user may input/select the first predefined duration. Alternatively, the first predefined duration corresponding to each of the food type and/or each of the cooking type is prestored inside the memory 174.

The processor 172 controls the motor to raise the grill platform 130 for a second predefined duration or by a predetermined distance and stops the electric motor 116, and monitors the temperature of the grill platform 130, again based on signals from the temperature sensors 152 and averaging the respective readings. In an embodiment, the processor 172 may raise the grill platform 130 until the temperature of the grill platform 130 decreases below the maximum temperature value or to the desired temperature. The processor 172 may keep monitoring the temperature of the grill platform for a third predefined duration. The processor 172 may activate the electric motor 116 to lower the grill platform 130 if the detected temperature of the grill platform 130 falls below the minimum temperature corresponding to the desired temperature.

In an embodiment, the processor 172 may lower the grill platform 130 for a third predefined duration or a predefined distance, whereupon it again monitors the temperature of the grill platform 130 in the manner described above.

In this manner, the processor 172 iteratively raises and lowers the grill platform 130 to maintain the temperature of the grill platform 130 at the desired temperature and/or between the predetermined maximum and minimum temperatures. The processor 172 may maintain the grill platform 130 at a desired height corresponding to the desired temperature for a desired time duration.

In an embodiment, the desired time duration is determined from inputs by the user. In an embodiment, the desired time duration is determined by the type of cooking and the type of food, and that time is prestored in memory 174. After the grill platform 130 is maintained at the desired temperature for the desired time duration, the processor 172 may generate an alarm indicating to the user, via the connected display device, that food has been cooked. Accordingly, the user may extinguish the fire or (more commonly) simply remove the food from the grill platform 130. Further, the grill may simply be elevated to a height to effectively stop cooking food product, but instead to keep it warm.

In some embodiments, the controller 170 may monitor the temperature reading from the temperature probe 160 in conjunction with the temperature of the grill platform 130 grill platform height. In this manner, the grill enables fine control of an otherwise unruly cooking process.

In embodiments, the table may be provided with an aperture through which a torch end or nozzle of a propane starter may be disposed. The nozzle may be coupled via a hose to a propane tank.

As will be appreciated, power for the controller and the grill motor may be provided through a power cord connected to a conventional A/C power source, preferably an outdoor power outlet. In embodiments, however, the system may also be provided with an A/C adapter and configured for use with a cordless power platform employing a plurality of interchangeable 18V, 20V, 24V, 36V, 40V, 60V, or even 80V batteries, such as those manufactured and sold by DeWalt, Milwaukee, Black & Decker, Porter Cable, Bosch, Hitachi, Hilti, Makita, Ryobi, Stihl, Husqvarana, Rigid, Cobalt, Worx, Ego, Greenworks, and others.

The foregoing disclosure is sufficient to enable one of ordinary skill in the art to practice the invention and provides the best mode of practicing the invention presently contemplated by the inventors. While there is provided herein a full and complete disclosure of the preferred embodiments of this invention, it is not desired that the disclosure limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A barbecue grill, comprising:
a table defining a fire chamber to receive wood or charcoal to contain and shape a cooking fire;
a carriage assembly mounted to said table and configured with a linear axis drive;
a grill basket coupled to said carriage assembly and having a grill platform arranged above said fire chamber, said grill basket adapted to be translated vertically between an upper and lower range of heights above said fire chamber;
a reversible electric motor operatively and mechanically coupled to said to carriage assembly to actuate and motorize the vertical translation of said grill basket;
a control system including a plurality of temperature sensors adapted to monitor a temperature of the grill platform and a controller in wired or wireless communication with said plurality of temperature sensors and said electric motor, said controller configured to operate said reversible electric motor in response to temperature readings from said plurality of temperature sensors to raise and lower said grill basket to maintain said grill platform at a desired temperature.

2. The barbeque grill of claim 1, further including a bracket assembly disposed between and movably coupling said grill basket and said carriage assembly.

3. The barbeque grill of claim 2, wherein said carriage assembly includes a frame affixed to said table, a telescopic cylinder having a first end attached to said frame, and a second end engaging said bracket assembly, and where said bracket assembly moves up and down as said telescopic cylinder is extended and retracted.

4. The barbeque grill of claim 3, wherein said reversible electric motor is operatively coupled to said telescopic cylinder, wherein said telescopic cylinder extends or retracts according to the direction of rotation of said electric motor.

5. The barbeque grill of claim 3, wherein said bracket assembly includes a pair of guide rods connected to a bracket and extending through a plurality of guide brackets of said carriage assembly.

6. The barbeque grill of claim 5, wherein said guide brackets are affixed to said frame and are configured to guide vertical motion of said guide rods.

7. The barbeque grill of claim 6, wherein said grill platform includes an outer frame, a plurality of grill rods arrayed along a length of said grill platform and attached to said outer frame, and a pair of arms arranged at opposing lateral ends of said grill platform and connecting said outer frame to said bracket assembly.

8. The barbeque grill of claim 7, wherein said plurality of temperature sensors are mounted on said grill platform.

9. The barbeque of claim 7, wherein said some of said plurality of temperature sensors are incorporated into cylindrical cavities in said grill rods.

10. The barbeque grill of claim 7, wherein said control system further includes a display device having a user interface, and an input device, wherein a user can input a desired temperature at which food is to be cooked using said input device.

11. The barbeque grill of claim 1, wherein said user interface is accessed using an application installed on network connectable computing device selected from the group consisting of a smart phone, a laptop, a desktop computer, and a tablet.

12. The barbeque grill of claim 11, further including at least one temperature probe adapted for insertion inside food cooking on said grill platform, wherein said at least one temperature probe is adapted to determine a temperature of the food during cooking and to transmit a signal to said controller indicating food product temperature, wherein said controller in response to temperature readings from said at least one temperature probe controls the height-adjustment operation of said grill basket.

13. The barbeque grill of claim 12, wherein said controller is configured to control the height of said grill platform above said fire chamber based on a cooking mode selected and input by a user through said input device.

14. The barbeque grill of claim 1, wherein said control system includes memory for data storage, and wherein said memory is physically connected to said controller.

15. The barbeque grill of claim 1, wherein said user interface is provided through a smart phone.
